(19) United States
(12) Patent Application Publication
(10) Pub. No.: US 2018/0251919 A1
(43) Pub. Date: Sep. 6, 2018

(54) THREE-DIMENSIONAL LATTICE AND METHOD OF MAKING THE SAME

(71) Applicant: GM GLOBAL TECHNOLOGY OPERATIONS LLC, DETROIT, MI (US)

(72) Inventors: Nilesh D. Mankame, Ann Arbor, MI (US); Elisabeth J. Berger, Farmington Hills, MI (US); William R. Rodgers, Bloomfield Township, MI (US); David A. Okonski, Waterford, MI (US)

(21) Appl. No.: 15/447,806

(22) Filed: Mar. 2, 2017

(51) Int. Cl. D03D 3/08; B32B 5/02; B32B 5/26; B32B 37/20; B32B 38/00; B29C 65/00; B60N 2/00; B60N 2/56; A47C 5/02

(52) U.S. Cl. CPC D03D 3/08; B29L 2031/771; B32B 5/028; B32B 5/26; B32B 37/203; B32B 38/0012; B29C 66/0324; B29C 66/45; B29C 66/729; B60N 2/002; B60N 2/56; A47C 5/02; B32B 2250/02; B32B 2250/20; B32B 2262/0253; B32B 2262/0261; B32B 2305/188; B32B 2305/38; B32B 2305/345; B32B 2323/04; B32B 2323/10; B32B 2377/00; B32B 2479/00; B32B 2305/34; B29K 2623/10; B29K 2623/04; B29K 2677/10; B32B 5/024

(57) ABSTRACT

A three-dimensional lattice includes a stabilizing grid having grid warp strands and grid weft strands crossing the grid warp strands. Grid cells are defined by adjacent grid warp strands and adjacent grid weft strands intersecting the adjacent grid warp strands. A projecting net has net warp strands and net weft strands crossing the net warp strands. Each subnet in a plurality of subnets uniquely corresponds to a corresponding grid cell. Each subnet includes a net warp strand portion intersecting both of the grid weft strands that define the corresponding grid cell. Each subnet includes a net weft strand portion intersecting both of the grid warp strands that define the corresponding grid cell. The net warp strand portion and the net weft strand portion of each subnet are spaced from a minimum surface defined by the corresponding grid cell.

### INTRODUCTION

A three-dimensional lattice is a three-dimensional structure like a truss or a network. A three-dimensional lattice may have a loosely spaced three-dimensional network. A woven rattan chair is an example of a tightly spaced three-dimensional lattice. Rattan is a strong, wood-like vine that is steamed to make the rattan pliable so it can be woven and shaped. The thickness of the rattan vine causes roughness and undulation in the thickness direction of the surfaces of the woven rattan chair. Some plastic materials may be injection molded to form a three-dimensional lattice. For example, an injection molded patio chair may have an injection molded three-dimensional seating surface to allow rain water to drain off of the chair and to make the seating surface more comfortable. As a three-dimensional lattice becomes larger, injection molding tooling becomes much more complicated. In some cases, injection molding is impractical or impossible.

Some vehicles use three-dimensional lattices for vehicle structural components (e.g., battery enclosure, floor pan, fill for closed sections such as rockers or A-pillars, etc.). A three-dimensional lattice may be used in seats to facilitate heating and cooling, and to make an air layer to provide insulation. A three-dimensional lattice may be used as an energy absorbing panel, acoustic barrier, or a thermal barrier.

### SUMMARY

A three-dimensional lattice includes a stabilizing grid having grid warp strands and grid weft strands crossing the grid warp strands. Grid cells are defined by adjacent grid warp strands and adjacent grid weft strands intersecting the adjacent grid warp strands. A projecting net has net warp strands and net weft strands crossing the net warp strands. Each subnet in a plurality of subnets uniquely corresponds to a corresponding grid cell. Each subnet includes a net warp strand portion intersecting both of the grid weft strands that define the corresponding grid cell. Each subnet includes a net weft strand portion intersecting both of the grid warp strands that define the corresponding grid cell. The net warp strand portion of each subnet is spaced from a minimum surface defined by the corresponding grid cell. The net weft strand portion of each subnet is spaced from the minimum surface defined by the corresponding grid cell.

### BRIEF DESCRIPTION OF THE DRAWINGS

Features and advantages of examples of the present disclosure will become apparent by reference to the following detailed description and drawings, in which like reference numerals correspond to similar, though perhaps not identical, components. For the sake of brevity, reference numerals or features having a previously described function may or may not be described in connection with other drawings in which they appear.

FIG. 1A is a semi-schematic top view of a portion of a three-dimensional lattice according to an example of the present disclosure;

FIG. 1B is a semi-schematic right side view of the portion of the three-dimensional lattice depicted in FIG. 1A;

FIG. 1C is a semi-schematic front view of the portion of the three-dimensional lattice depicted in FIG. 1A;

FIG. 2 is a semi-schematic top perspective view of heated contoured rollers and cooled contoured rollers for making the three-dimensional lattice according to an example of the present disclosure;

FIG. 3 is a semi-schematic perspective view of heated contoured rollers and cooled contoured rollers for making the three-dimensional lattice according to an example of the present disclosure;

FIG. 4 is a semi-schematic side view of a portion of an example of a production line for producing a continuous three-dimensional lattice;

FIGS. 5A-5J together are a flowchart depicting a method of making the three-dimensional lattice according to examples of the present disclosure;

FIG. 6 is a schematic view of a seat with a three-dimensional lattice that has strands with an active material to form a pressure sensor according to an example of the present disclosure; and

FIG. 7 is a schematic view of a seat with a three-dimensional lattice that has strands with an active material to form a heating or cooling layer in the seat according to an example of the present disclosure.

### DETAILED DESCRIPTION

The present disclosure relates generally to a textile-based thermoplastic three-dimensional lattice for structural applications.

Examples of the present disclosure include a three-dimensional lattice that is formed from textiles. Examples of the three-dimensional lattice disclosed herein are recyclable, and producible in a continuous process. Examples of the three-dimensional lattice may have an overall appearance as a roll of fabric with strands that project in a thickness direction of the fabric. Examples of the three-dimensional lattice of the present disclosure may be used in vehicle headliners, vehicle structural components (e.g. battery enclosures, floor pans, and/or fill for closed sections such as rockers or A-pillars). The three-dimensional lattice may be used in seats to facilitate heating and cooling, and to make an air layer to provide insulation. The three-dimensional lattice can be used in steering wheels to provide an air layer for insulation. The three-dimensional lattice may be used in vehicle roof structure as an energy absorbing panel, acoustic barrier, or a thermal barrier. The present disclosure also includes a method of making the three-dimensional lattice.

### Definitions

As used herein, the word “filament” means a single fiber. A single continuous filament that may be rolled on a spool is a “monofilament”. Filaments in a bunch are called a “strand” or an “end.” If the filaments are all parallel to each other, the “end” is called a “roving,” although graphite rovings are also referred to as “tows.” If the filaments are twisted to hold the fibers together, the bundle is called a “yarn.”

Either roving (tow) or yarn can be woven into a fabric. If roving is used, the fabric is called “woven roving;” if yarn is used, the fabric is called “cloth.”

Although the terms “strand” and “yarn” are not interchangeable, where the word “yarn” is applied in this document, it is to be understood that “strand” may be applied also. Nonwoven fabric is a fabric-like material such as “felt” made from long fibers, bonded together by chemical treatment, mechanical treatment, heat treatment, or solvent treatment.

In a roll of fabric, “warp strands” run in the direction of the roll and are continuous for the entire length of the roll. “Weft strands” run crosswise to the roll direction. Warp strands are usually called “ends” and weft strands “picks.”

Fabric count refers to the number of warp yarns (ends) and weft yarns (picks) per inch. For example, a 24×22 fabric has 24 ends in every inch of weft direction and 22 picks in every inch of warp direction. Note that warp yarns are counted in the weft direction, and weft yarns are counted in the warp direction.

If the end and pick counts are roughly equal, the fabric is considered “bidirectional” (BID). If the pick count is very small, most of the yarns run in the warp direction, and the fabric is nearly unidirectional. Some unidirectional cloths have no weft yarns; instead, the warp yarns are held together by a thin stream of glue. “Unidirectional prepreg” relies on resin to hold the fibers together.

“Weave” describes how the warp and weft strands are interlaced. Examples of weaves are “plain,” “twill,” “harness satin,” and “crow-foot satin.” Weave determines drapeability and isotropy of strength.

“Composite material” means engineered material made from two or more constituent materials with significantly different physical or chemical properties which remain separate and distinct on a macroscopic level within the finished structure. There are two categories of constituent materials: matrix and reinforcement. The matrix material surrounds and supports the reinforcement material by maintaining their relative positions. The reinforcements impart their special mechanical and physical properties to enhance the matrix properties. A synergism produces material properties unavailable from the individual constituent materials. Reinforcement materials include fiberglass, carbon fiber, aramid fiber, mineral and/or nanoparticles, and the like.

As used herein, an “active material” means an electrically conductive material, a piezoelectric material, a piezo resistive material, a ferromagnetic material, a shape memory material, a material that swells or shrinks in response to a stimulus, a dielectric material, a photo-sensitive material, a chemically sensitive material, or combinations thereof

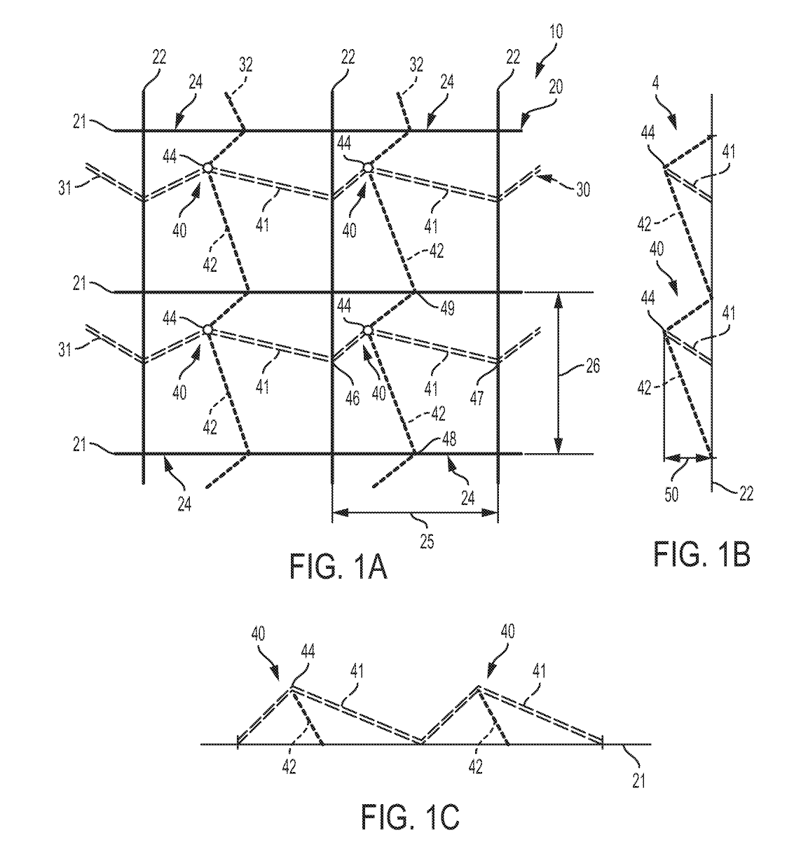

FIG. 1A is a semi-schematic top view of a portion of a three-dimensional lattice 10 according to the present disclosure. The three-dimensional lattice 10 includes a stabilizing grid 20 having grid warp strands 21 and grid weft strands 22 crossing the grid warp strands 21. The grid warp strands 21 may be orthogonal to the grid weft strands 22. The grid warp strands 21 may be oblique to the grid weft strands 22. Grid cells 24 are defined by adjacent grid warp strands 21 and adjacent grid weft strands 22 intersecting the adjacent grid warp strands 21. Therefore, four complete grid cells 24 are illustrated in FIG. 1A.

FIG. 1A depicts a projecting net 30 superimposed on the stabilizing grid 20. The projecting net 30 has net warp strands 31 and net weft strands 32 crossing the net warp strands 31. The net warp strands 31 may be orthogonal to the net weft strands 32. The net warp strands 31 may be oblique to the net weft strands 32. It is to be understood that the net warp strands 31are depicted in a double dashed line font in FIGS. 1A-1C. The double dashed line font is used to distinguish the net warp strands 31 from other strands. The double dashed line font is not to convey a limitation on a number of fibers or strands, and the double dashed line font is not a hidden line in FIGS. 1A-1C. It is to be further understood that the net weft strands 32 are depicted in a dashed line font in FIGS. 1A-1C. The dashed line font is used to distinguish the net weft strands 32 from other strands. The dashed line font is not to convey a limitation on a number of fibers or strands, and the dashed line font is not a hidden line in FIGS. 1A-1C.

Examples of the present disclosure include a three-dimensional lattice 10 as depicted in FIG. 1A-FIG. 1C with plurality of subnets 40. Each subnet 40 uniquely corresponds to a corresponding grid cell 24. Each subnet 40 includes a net warp strand portion 41 intersecting both of the grid weft strands 22 that define the corresponding grid cell 24. Each subnet 40 also includes a net weft strand portion 42 intersecting both of the grid warp strands 21 that define the corresponding grid cell 24.

The net warp strand portion 41 spans the corresponding grid cell 24. To illustrate, a net warp strand portion 41 spans from a first intersection at reference numeral 46 to a second intersection at reference numeral 47. In the preceding sentence, “first” and “second” are for distinguishing the intersections from other intersections as an aid to the reader. In this instance, “first” and “second” do not convey any order or precedence. As used herein, the “length” of a strand portion means the rectified length of the strand portion; i.e. the length that a curved or bent strand portion would have if the strand portion were straightened and measured. In examples of the present disclosure, the net warp strand portion 41 of each subnet 40 may be longer than a grid weft distance 25 between the grid weft strands 22 that define the corresponding grid cell 24. As disclosed herein, the grid weft distance 25 means the distance between parallel grid weft strands 22. In examples of the present disclosure, the net warp strand portion 41 of each subnet 40 may be spaced from a minimum surface defined by the corresponding grid cell 24.

Similarly, a net weft strand portion 42 spans from a primary intersection at reference numeral 48 to a secondary intersection at reference numeral 49. In the preceding sentence, “primary” and “secondary” are for distinguishing the intersections from other intersections as an aid to the reader. In this instance, “primary” and “secondary” do not convey any order or precedence. The net weft strand portion 42 of each subnet 40 is longer than a grid warp distance 26 between the grid warp strands 21 that define the corresponding grid cell 24. In examples of the present disclosure, the net weft strand portion 42 of each subnet 40 is spaced from the minimum surface defined by the corresponding grid cell 24.

FIG. 1A shows the stabilizing grid 20 and the projecting net 30 oriented generally parallel to one another. Generally parallel means that there may be some variation from parallel, but the grid warp strands 21 and the net warp strands 31 run somewhat parallel to one another. Similarly, the grid weft strands 22 and the net weft strands 32 are generally parallel. However, in other examples that are not shown, the stabilizing grid 20 may be oblique to the projecting net 30. For example, the grid warp strands 21 may be from about 30 degrees to about 45 degrees to the net warp strands 31.

Further, the concepts of the present disclosure may be applied to biaxial fabrics and multiaxial fabrics, for example tri-axial fabrics. Biaxial fabric is non-woven. It consists of two layers that are stitched together. Rather than having the strands lying along the roll and across at 90 degrees as in conventional woven fabrics, the strands lie at a predetermined angle to the edges, e.g. +/−45 degrees. Triaxial fabrics are made of three layers of parallel strands laid in any three orientations and stitched together. For example strands may be oriented at 0°±45° or 0°±60°. The longitudinal direction 0° is the direction of the length of the roll and stitching direction. Triaxial fabrics may have strands oriented at +45°, 90°, and −45°; or +60°, 90°, and −60°. The layers may be combined in any order.

Each subnet 40 may have a subnet node 44 defined at an intersection of the net warp strand portion 41 and the net weft strand portion 42 of each subnet 40. The three-dimensional characteristic of the three-dimensional lattice 10 is from the subnet node 44 being projected, i.e. spaced, from a minimum surface defined by the corresponding grid cell 24. As used herein, the minimum surface means the surface having the smallest continuous surface area within a perimeter. As an illustration, if the stabilizing grid 20 is defined in a plane, then the minimum surfaces defined by the grid cells 24 would be planar surfaces. In such an example, each subnet node 44 is spaced by a thickness 50 away from the planar surface defined by the corresponding grid cell 24 as shown in FIG. 1B. However, the three-dimensional lattice 10 of the present disclosure is not necessarily limited to having a planar stabilizing grid 20. For example, the stabilizing grid 20 may be wrapped around a cylinder. In such a case, the stabilizing grid 20 would define a portion of a cylindrical surface, and the minimum surface defined by each grid cell 24 would be a portion of the cylindrical surface. In such an example, each subnet node 44 is spaced by a thickness 50 away from the cylindrical surface that is the minimum surface defined by the corresponding grid cell 24 as shown in FIG. 1B.

In examples of the present disclosure, the grid warp strands 21 and the grid weft strands 22 may include reinforcing fibers and a thermoplastic resin. The grid warp strands 21, the grid weft strands 22, the net warp strands 31and/or the net weft strands 32 may have a combination of the thermoplastic resin and reinforcements. The reinforcements may include reinforcing fibers or nanoparticles. The reinforcing fibers may be continuous fibers, long fibers or short fibers. The grid warp strands 21 and the grid weft strands 22 may have a higher glass transition temperature or a higher softening point resin than the net warp strands 31and net weft strands 32. Examples may include any combination of materials with such glass transition temperature or softening point characteristics. Therefore, the stabilizing grid 20 can retain its shape when the projecting net 30 is stretched to elongate the net warp strand portions 41 and the net weft strand portions 42 to form the subnets 40 that contribute to the three-dimensional characteristics of the lattice disclosed herein.

In an example, the grid warp strands 21 and the grid weft strands 22 that form the stabilizing grid 20 may be made from polypropylene, and the net warp strands 31and net weft strands 32 that form the projecting net 30 may be made from polyethylene. The melting/softening point of polypropylene is about 170° C.; and the melting/softening point of polyethylene is about 122° C. At an intermediate temperature between the melting/softening point of the polypropylene and the melting/softening point of the polyethylene, the polyethylene would become malleable while the polypropylene would remain rigid. In another example, the grid warp strands 21 and the grid weft strands 22 that form the stabilizing grid 20 may be made from polyamide 4T (a partially aromatic polyamide), and the net warp strands 31and net weft strands 32 that form the projecting net 30 may be made from polyamide 6,6. The melting/softening point of polyamide 4T is about 325° C.; and the melting/softening point of polyethylene is about 269° C. The glass transition temperature (Tg) of polyamide 4T is about 125° C.; and the Tg of polyethylene is about 67° C. Thus, at a temperature below the Tg of the stabilizing grid 20, but above the Tg of the projecting net 30, will allow the projecting net 30 to be become malleable while the stabilizing grid 20 holds its shape.

In examples the stabilizing grid 20 and the projecting net 30 may be established together, by, for example, extrusion of the stabilizing grid 20 and the projecting net 30 simultaneously together as a single lattice. In another example, the stabilizing grid 20 and the projecting net 30 may be woven simultaneously and together to form the single lattice. In examples, the grid warp strands 21, the grid weft strands 22, the net warp strands 31and the net weft strands 32 may be composed of a same material. In other examples, the strands 21, 22, 31, and 32 may be composed of different materials.

In examples of the present disclosure, the stabilizing grid 20 may be established by forming the grid warp strands 21, forming the grid weft strands 22, and weaving the grid warp strands 21 and the grid weft strands 22 together to form the stabilizing grid 20 having original cell shapes. As disclosed herein, forming the grid warp strands 21 may include extruding the grid warp strands 21. Forming the grid weft strands 22 may include extruding the grid weft strands 22. As disclosed herein, forming the grid warp strands 21 may include pultruding the grid warp strands 21 with fiberglass or carbon fibers. Forming the grid weft strands 22 may include pultruding the grid weft strands 22 with fiberglass or carbon fibers.

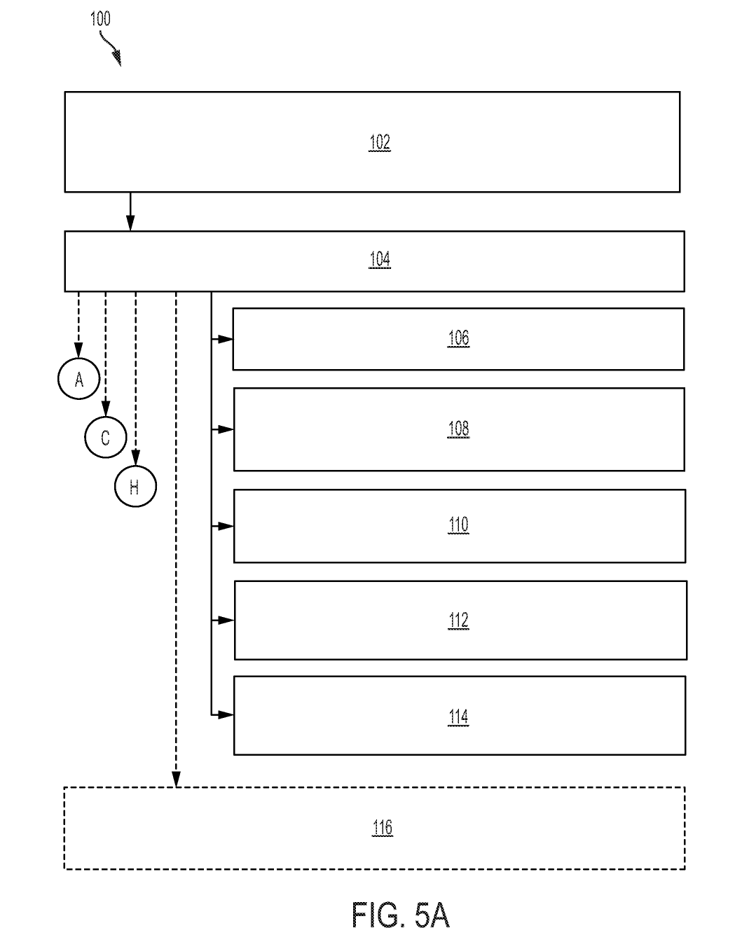

Similarly, the projecting net 30 may be established by extruding the net warp strands 31, extruding the net weft strands 32, and weaving of the net warp strands 31 and the net weft strands 32 together to form an undeformed net 36. (See e.g. FIG. 4.)

In examples of the present disclosure, as an alternative to the single lattice described above, a double-layer network 37 may be used. The double-layer network 37 may be made by merging the stabilizing grid 20 into contact with the undeformed net 36, and joining the stabilizing grid 20 and the undeformed net 36 together to form the double-layer network 37. As used herein, “joining” means permanently attaching two bodies by heat staking, welding (e.g. ultrasonic welding, thermal welding, chemical welding), adhesively bonding, stitching, or combinations thereof

In examples of the present disclosure, the stabilizing grid 20 or the projecting net 30 may have active material fibers for heating, sensing, or switching. The active material may an electrically conductive material or any other active material as described above. In an example, at least one of the grid warp strands 21, at least one of the grid weft strands 22, at least one of the net warp strands 31 or at least one of the net weft strands 32 includes an active material. In another example, at least one of the grid warp strands 21 or at least one of the grid weft strands 22 includes a grid active material. In still another example, at least one of the net warp strands 31 or at least one of the net weft strands 32 includes a net active material. As used herein, the terms “grid” and “net” in “grid active material” and “net active material” are meant to provide distinguishing antecedent basis for the active materials. A “grid active material” may be different from a “net active material”; however, the “grid active material” may be the same type of material as the “net active material”. For example, the grid active material may be an electrically conductive material, and the net active material may also be an electrically active material. In another example, the grid active material may be electrically conductive, and the net active material may be a shape memory plastic.

It is to be understood that there may be additional strands woven into the stabilizing grid 20 and/or the projecting net 30. For example, if the stabilizing grid is sparsely woven, filler strands (not shown) may be woven between the grid warp strands 21 and/or the grid weft strands 22. The filler strands may be any material, and may be interwoven in any pattern on the stabilizing grid 20. For example, a conductive strand may be arranged in a spiral on the stabilizing grid 20 as part of a Fresnel zone antenna (not shown). The filler strands may also be overlaid upon the stabilizing grid without weaving the filler strands into the stabilizing grid 20. Filler strands may be applied in a similar manner to the projecting net 30, or the three-dimensional lattice 10 as a whole.

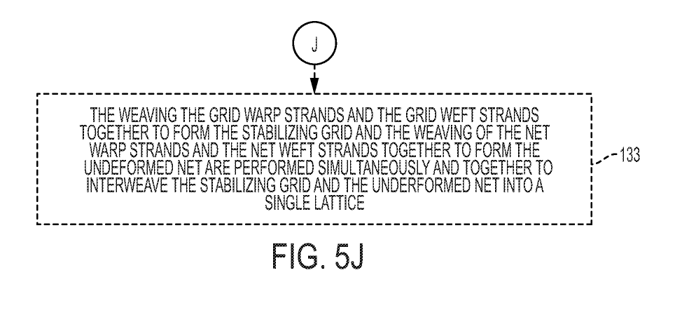

As depicted in FIG. 6, a seat 12 having the three-dimensional lattice 10 is disclosed herein. The seat 12 may be a vehicle seat, or any other seat for supporting a seat occupant such as a human in a sitting position. For example, the seat may be a chair or a recliner. In an example, at least one of the grid warp strands 21, at least one of the grid weft strands 22, at least one of the net warp strands 31 or at least one of the net weft strands 32 includes an active material. The seat 12 may further include a pressure sensor 14 operatively connected to a seating surface 17 of the seat 12. The active material included in at least one of the grid warp strands 21, the active material included in at least one of the grid weft strands 22, the active material included in at least one of the net warp strands 31 or the active material included in at least one of the net weft strands 32 define a Wheatstone Bridge 29 for pressure sensing.

In another example depicted in FIG. 7, the seat 12′ with the three-dimensional lattice 10′ may have a heating layer 28 or a cooling layer 28′ operatively connected to a seating surface 17 of the seat 12′. The at least one of the grid warp strands 21 including the active material, the at least one of the grid weft strands 22 including the active material, the at least one of the net warp strands 31 including the active material or the at least one of the net weft strands 32 including the active material are operatively included in the heating layer 28 or the cooling layer 28′.

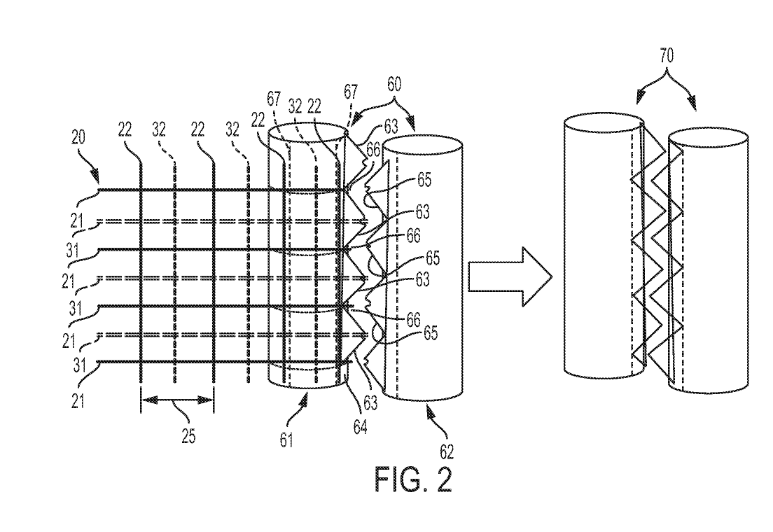

FIG. 2 is a semi-schematic top perspective view of heated contoured rollers and cooled contoured rollers for making the three-dimensional lattice 10 as disclosed herein. The heated contoured rollers 60 include a positive roller 61 and a complementary roller 62. The positive roller 61 has a plurality of cogs 63 protruding from a cylindrical roller surface 64. The plurality of cogs 63 is meshingly engaged with the stabilizing grid 20 without deforming the stabilizing grid 20. The plurality of cogs 63 plastically deform the plurality of the net warp strands 31 and the plurality of the net weft strands 32 into complementary pockets 65 defined in the complementary roller 62 to receive the cogs 63 with the plurality of subnets 40 rolled between the cogs 63 and the complementary pockets 65. A plurality of circumferential valleys 66 is defined between the cogs 63. The plurality of circumferential valleys 66 are aligned to receive the grid warp strands 21 without deforming the stabilizing grid 20.

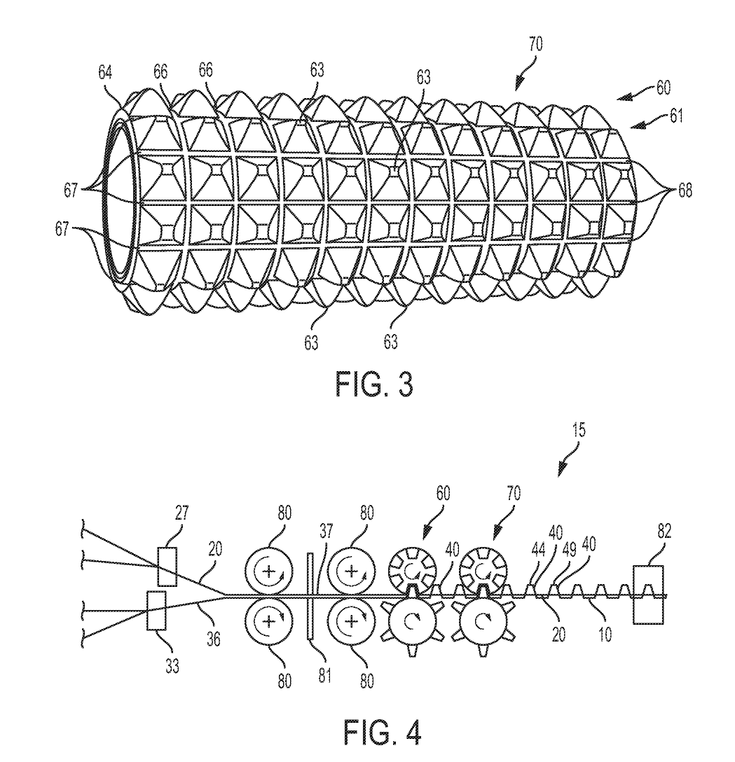

For drawing convenience and clarity, FIG. 2 depicts a single row of cogs 63 on the heated contoured rollers 60. It is to be understood that the positive roller 61 may be fully populated with cogs 63 as depicted in FIG. 3. In other examples of the present disclosure, some of the cogs may be eliminated, for example, to create patterns in the three-dimensional lattice 10. As best seen in FIG. 3, a plurality of longitudinal valleys 67 are defined in longitudinal rows 68 between the cogs 63. In FIG. 2, the longitudinal valleys 67 are shown schematically as dashed lines on the cylindrical roller surface 64. The longitudinal rows 68 are circumferentially spaced on the cylindrical roller surface 64 at intervals equal to the grid weft distance 25. The plurality of longitudinal valleys 67 are aligned to receive the grid weft strands 22 without deforming the stabilizing grid 20.

Therefore, in the example depicted in FIG. 2 a plurality of the net warp strands 31 and a plurality of the net weft strands 32 are plastically deformed by rolling the single lattice or the double-layer network 37 between the heated contoured rollers 60 to make the net warp strand portion 41 of each subnet 40 spaced from a minimum surface defined by the corresponding grid cell 24 and to make the net weft strand portion 42 of each subnet 40 spaced from the minimum surface defined by the corresponding grid cell 24.

Still referring to FIG. 2, after the plurality of the net warp strands 31 and a plurality of the net weft strands 32 are plastically deformed, the plurality of subnets 40 are set by cooling the single lattice or the double-layer network 37 to stabilize the single lattice or the double-layer network 37 as the three-dimensional lattice 10. Once the original cell shapes are established by extrusion or weaving into the stabilizing grid 20, the original cell shapes are unchanged throughout the process disclosed herein. That is, the original cell shapes are retained through the rolling of the single lattice or double-layer network 37 between the heated contoured rollers 60 and through the cooling of the single lattice or double-layer network 37 as the three-dimensional lattice 10.

In the example depicted in FIG. 2, the cooling of the single lattice or double-layer network 37 as the three-dimensional lattice 10 may be accomplished by rolling the three-dimensional lattice 10 through cooled contoured rollers 70. The cooled contoured rollers 70 may have the same spatial dimensions as the heated contoured rollers 60. In examples, the three-dimensional lattice 10 may be cooled by passing a cooling fluid through the three-dimensional lattice 10. The cooling fluid may be, for example, air, nitrogen gas, water, or any suitable cooling fluid that does not react chemically with the three-dimensional lattice 10.

FIG. 3 is a semi-schematic perspective view of a heated contoured roller 60 or a cooled contoured roller 70 for making the three-dimensional lattice 10 as disclosed herein. Examples of the heated contoured roller 60 and the cooled contoured roller 70 may be similar in appearance. Therefore, in the interest of brevity, FIG. 3 represents both a heated contoured roller 60 and a cooled contoured roller 70. The heated contoured roller 60 may be heated by any suitable mechanism. For example, resistive or inductive heating elements may be disposed in the core of the heated contoured roller 60. A heated fluid may flow through the heated contoured roller. Similarly, the cooled contoured roller 70 may be cooled by any suitable mechanism. For example, a cooling fluid may flow through the cooled contoured roller or over the exterior of the cooled contoured roller. FIG. 3 depicts an example of a positive roller 61. The positive roller 61 has a plurality of cogs 63 protruding from a cylindrical roller surface 64. A plurality of circumferential valleys 66 is defined between the cogs 63. A plurality of longitudinal valleys 67 are defined in longitudinal rows 68 between the cogs 63.

FIG. 4 is a semi-schematic side view of a portion of a production line for producing continuous three-dimensional lattice 10. The stabilizing grid 20 is woven in a first loom 27 and the undeformed net 36 is woven in a second loom 33. The stabilizing grid 20 and the undeformed net 36 are merged together between idler rollers 80. The idler rollers 80 hold the stabilizing grid 20 and the undeformed net 36 together so that the joining device 81 can join the stabilizing grid 20 and the undeformed net 36 together to form the double-layer network 37. The double-layer network 37 is passed between the heated contoured rollers 60 to shape the projecting net 30. The heated contoured rollers 60 plastically deform a plurality of the net warp strands 31 and a plurality of the net weft strands 32 to make the net warp strand portion 41 of each subnet 40 spaced from a minimum surface defined by the corresponding grid cell 24 and to make the net weft strand portion 42 of each subnet 40 spaced from the minimum surface defined by the corresponding grid cell 24 (see FIG. 1A). After the plastic deformation by the heated contoured rollers 60, the cooled contoured rollers 70 cool and set the plurality of subnets 40 thereby stabilizing the double-layer network 37 in the form of the three-dimensional lattice 10. In FIG. 4, the subnet nodes 44 project i.e. are spaced, from the stabilizing grid 20. The stabilizing grid 20 is depicted as planar in FIG. 4 after exiting the cooled contoured rollers 70. An activation processor 82 is depicted in FIG. 4 to process the three-dimensional lattice 10 after exiting the cooled contoured rollers. The activation processor 82 performs processes that may enhance functions of the three-dimensional lattice 10. For example, the activation processor 82 may apply a coating to the three-dimensional lattice to enhance sensor performance. In another example, the activation processor 82 may apply a resin to create a composite structure. In another example, the activation processor 82 may apply additional layers to the three-dimensional lattice 10.

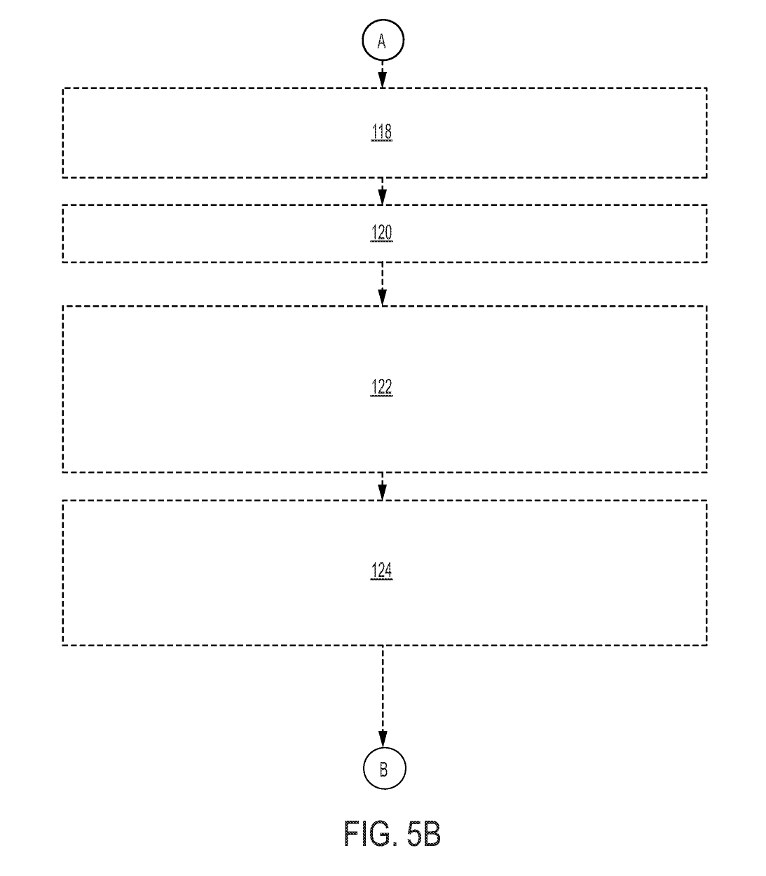

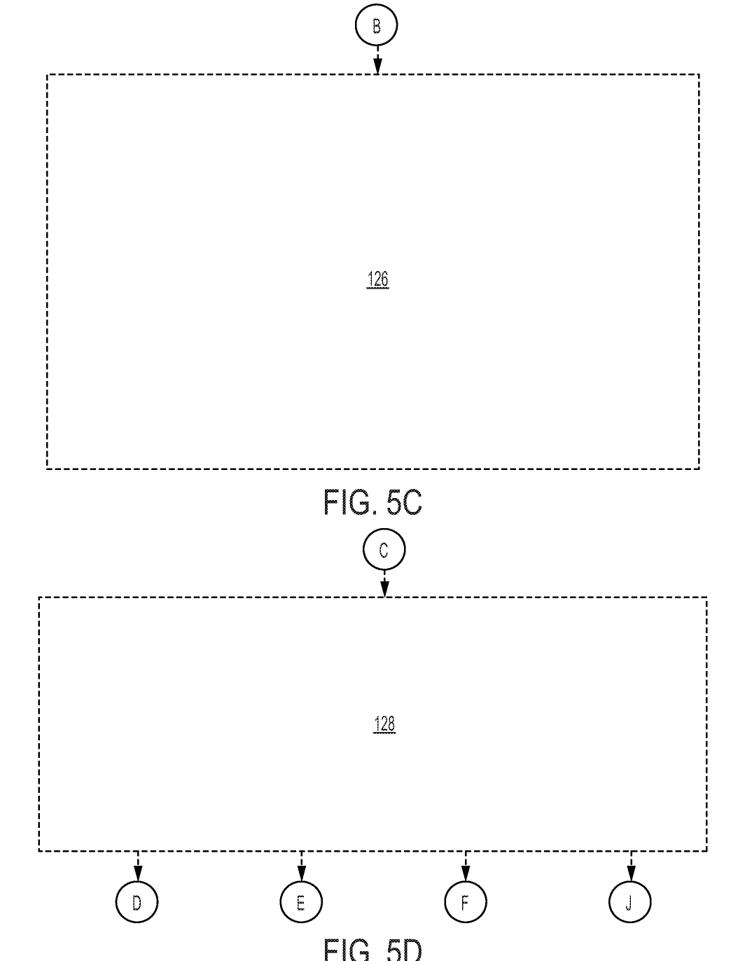

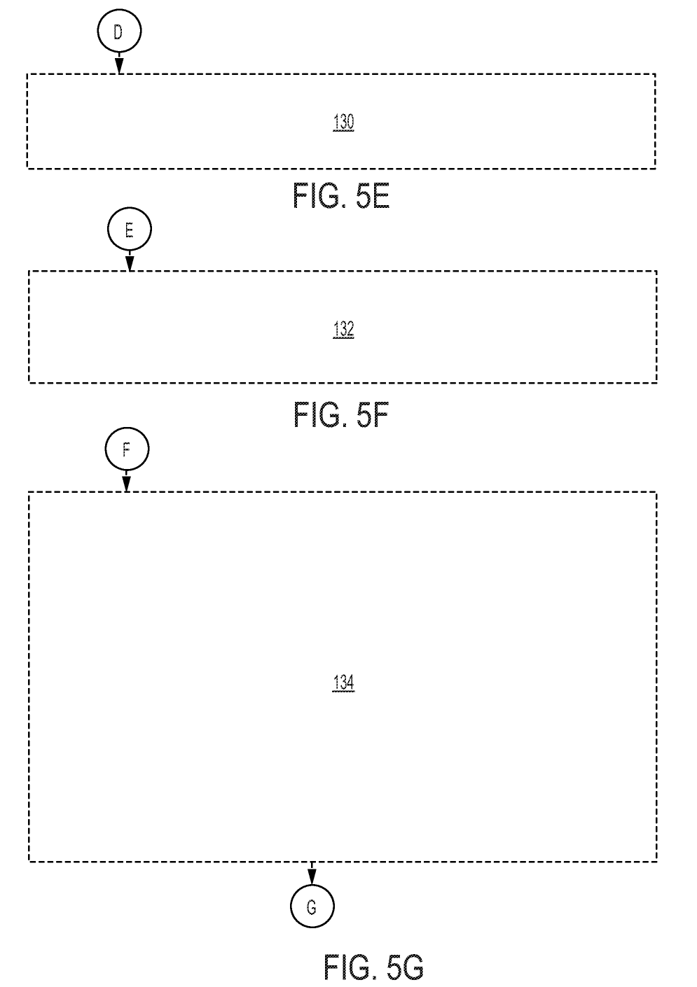

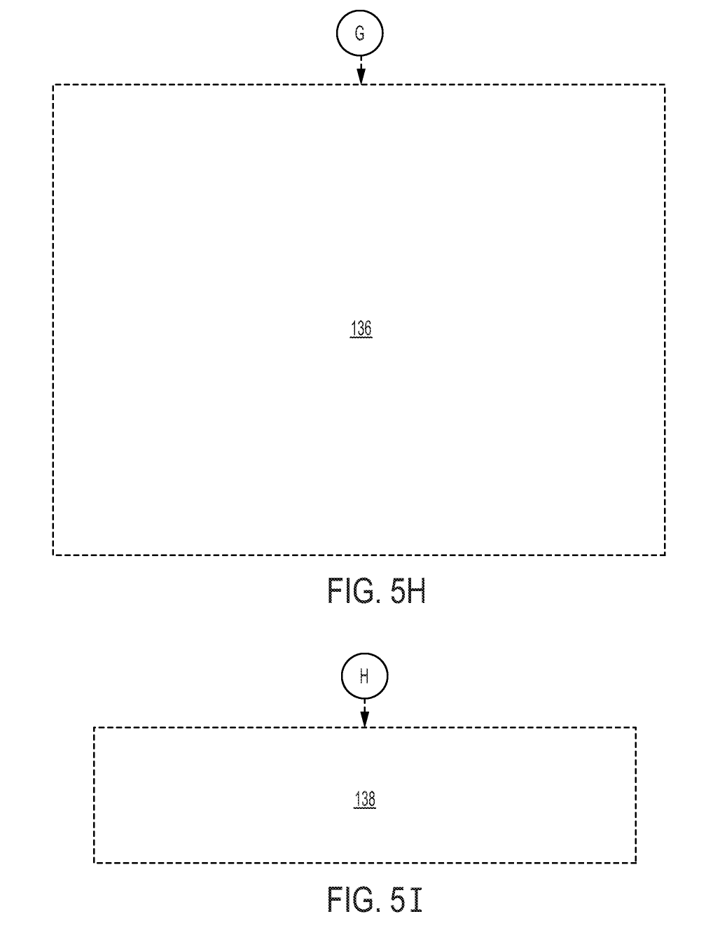

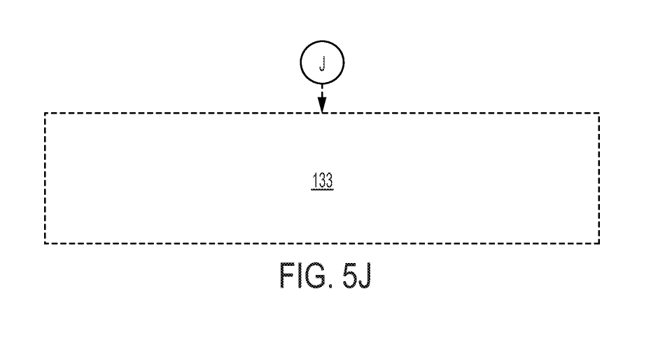

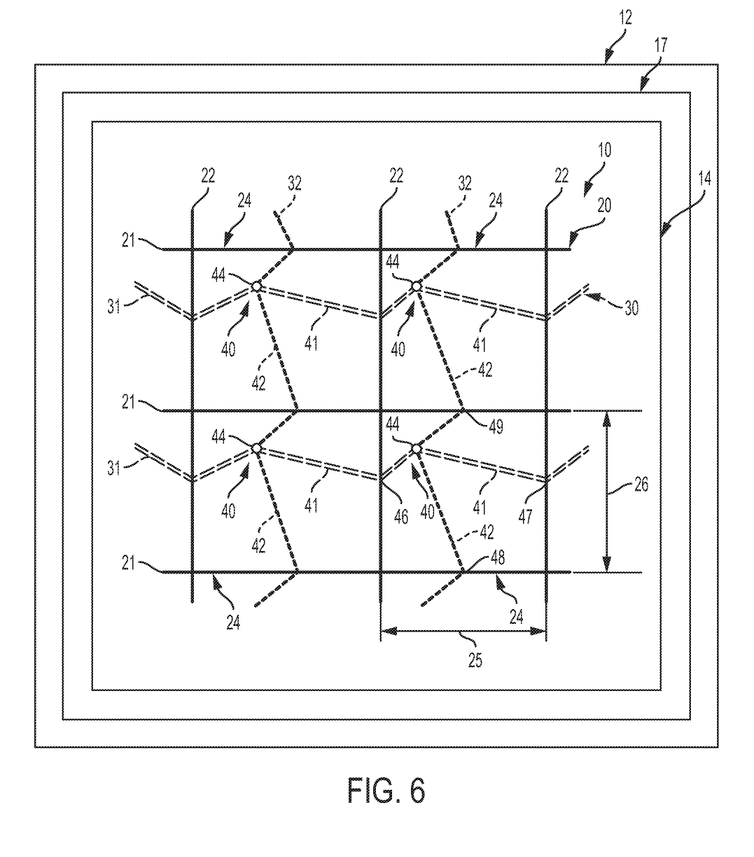

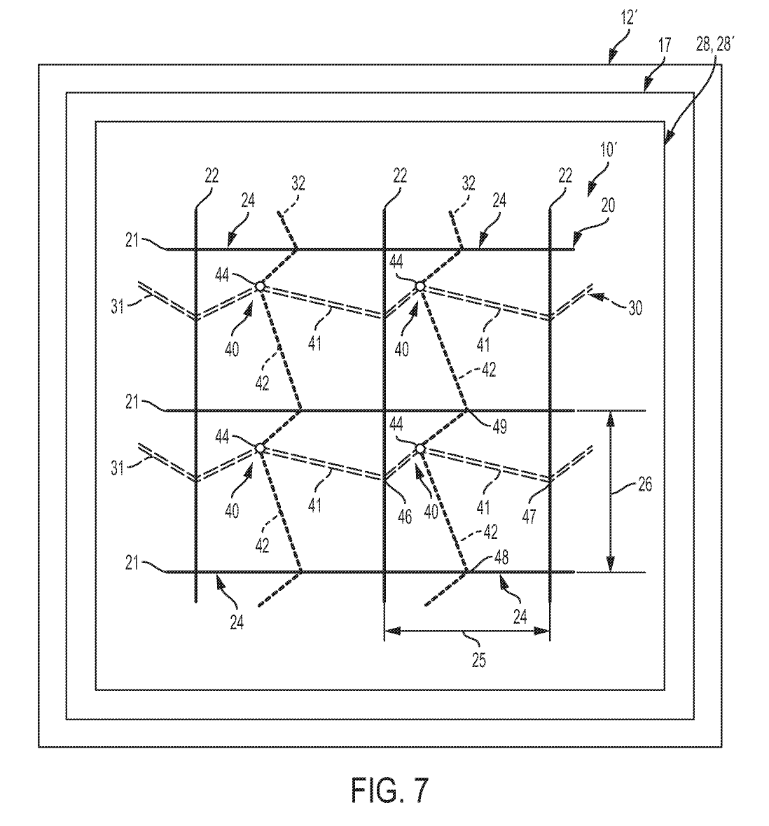

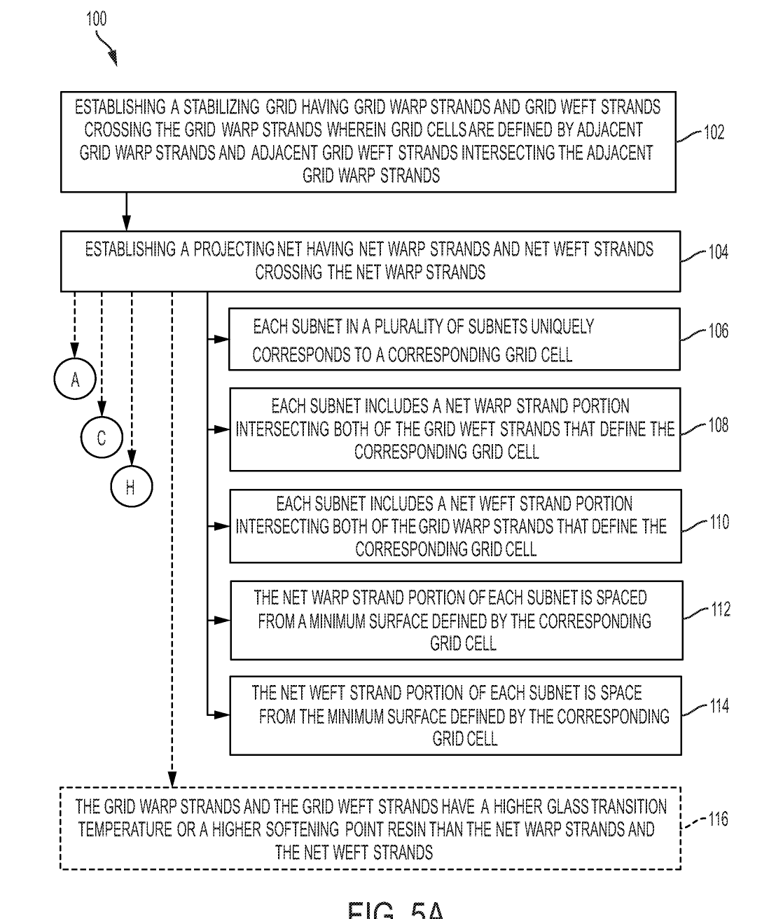

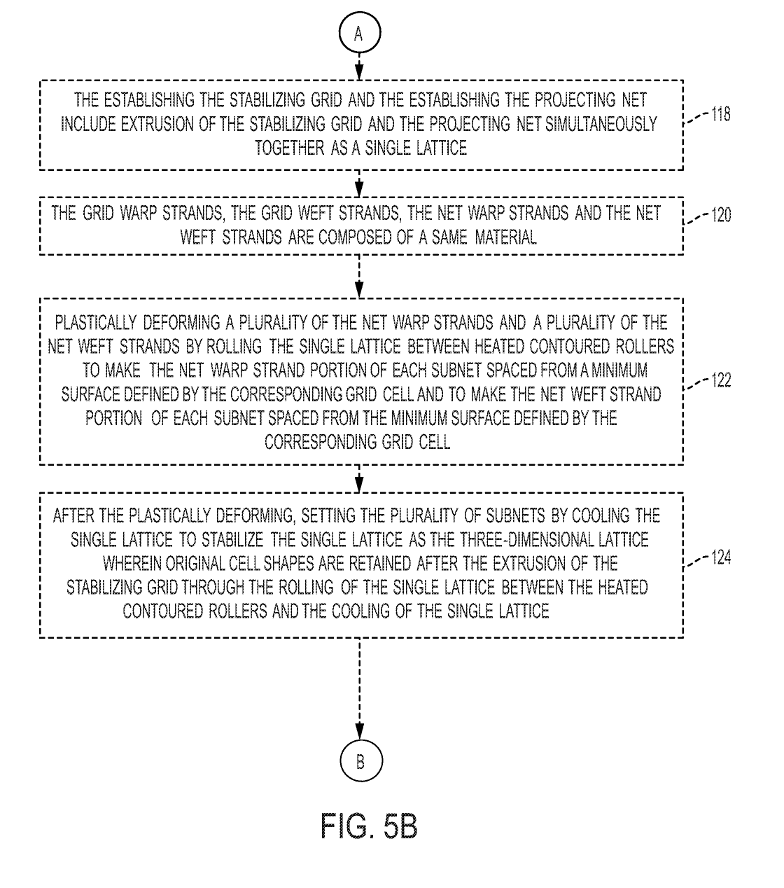

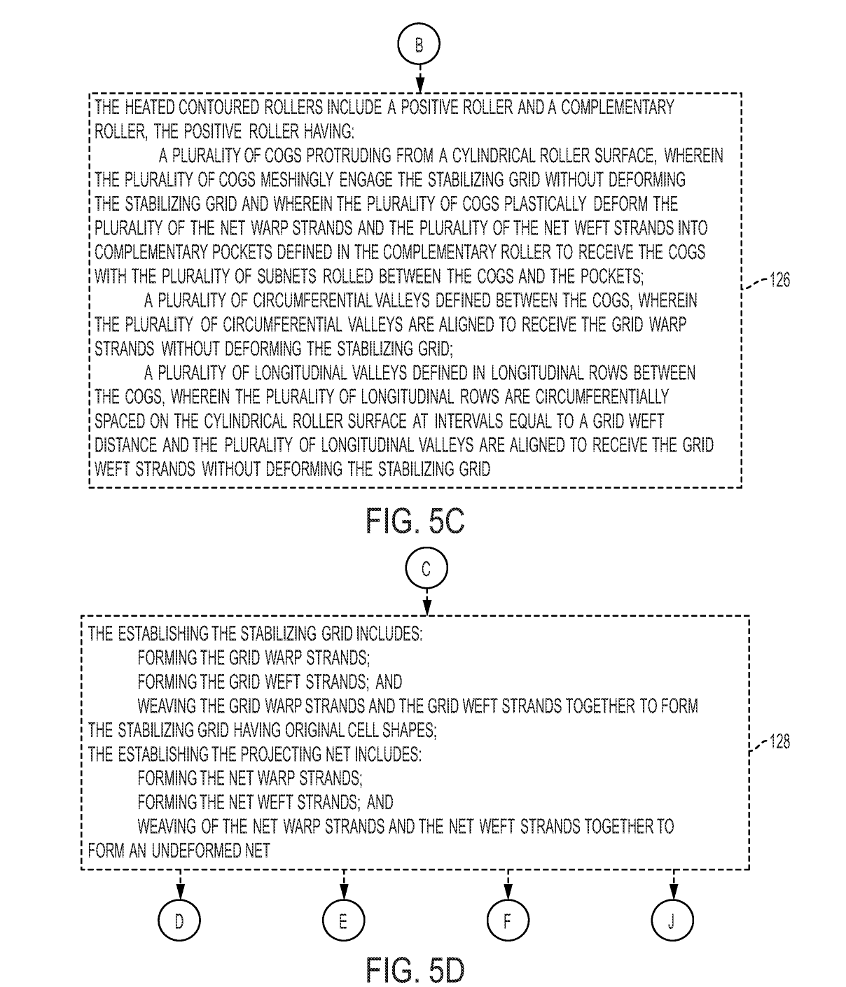

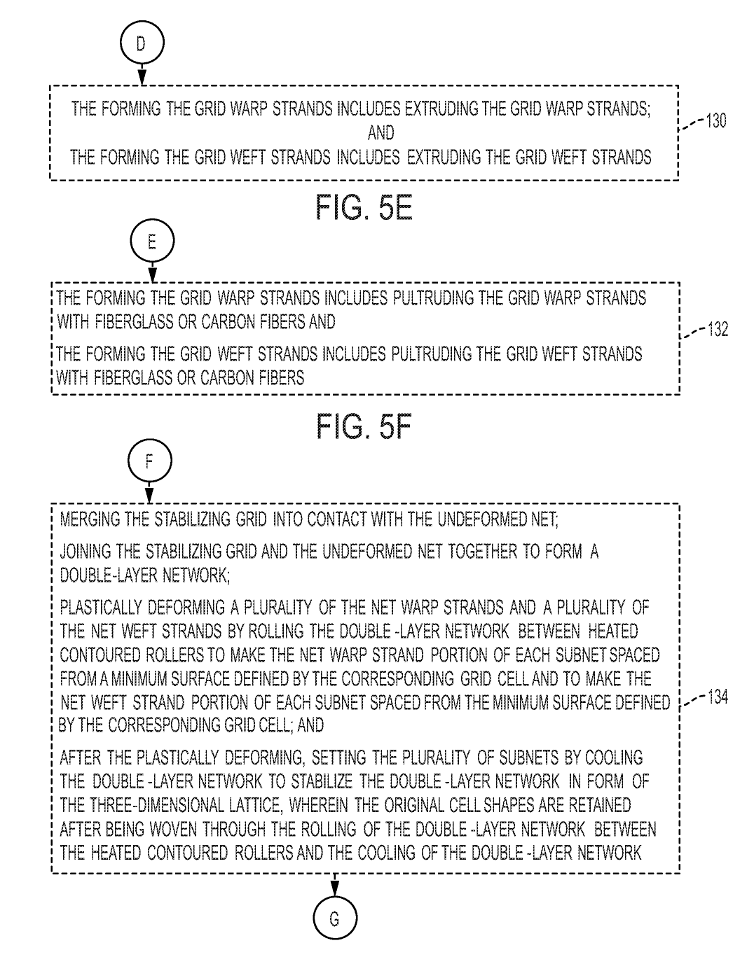

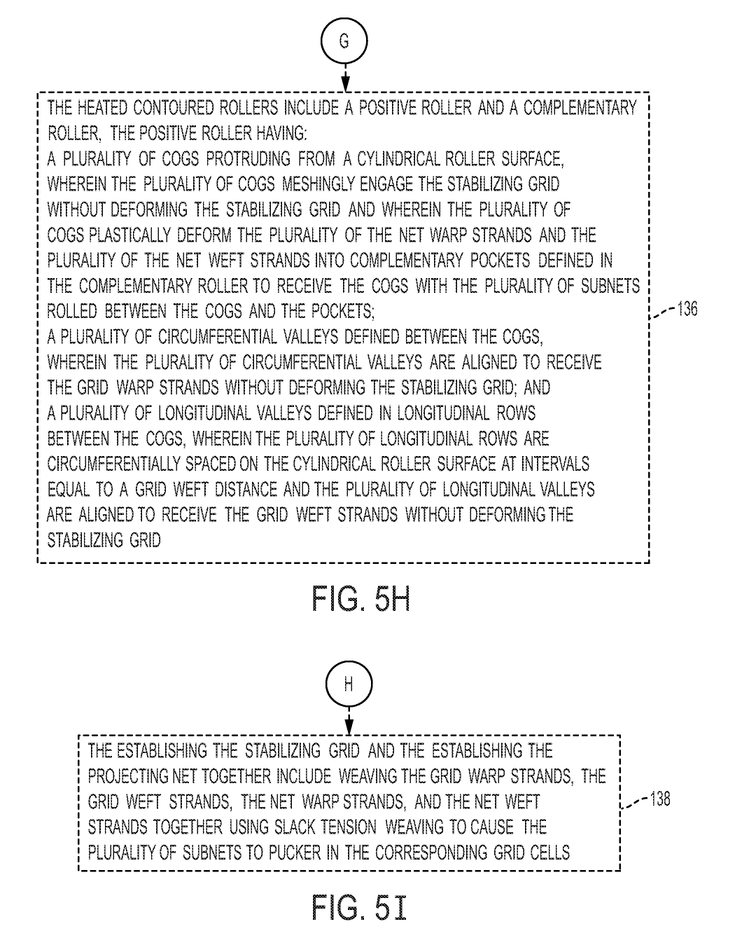

FIGS. 5A-5J together are a flowchart depicting an example of a method 100 of making the three-dimensional lattice 10 as disclosed herein. At box 102 is “establishing a stabilizing grid having grid warp strands and grid weft strands crossing the grid warp strands wherein grid cells are defined by adjacent grid warp strands and adjacent grid weft strands intersecting the adjacent grid warp strands.” At box 104 is “establishing a projecting net having net warp strands and net weft strands crossing the net warp strands.” At box 106 is “each subnet in a plurality of subnets uniquely corresponds to a corresponding grid cell.” At box 108 is “each subnet includes a net warp strand portion intersecting both of the grid weft strands that define the corresponding grid cell.” At box 110 is “each subnet includes a net weft strand portion intersecting both of the grid warp strands that define the corresponding grid cell.” At box 112 is “the net warp strand portion of each subnet is spaced from a minimum surface defined by the corresponding grid cell.” At box 114 is “the net weft strand portion of each subnet is spaced from the minimum surface defined by the corresponding grid cell.” At box 116 is “the grid warp strands and the grid weft strands have a higher glass transition temperature or a higher softening point resin than the net warp strands and the net weft strands.” Flow chart connector A connects box 104 of FIG. 5A with the top of FIG. 5B. Flow chart connector C connects box 104 of FIG. 5A with the top of FIG. 5D. Flow chart connector H connects box 104 of FIG. 5A with the top of FIG. 51.

FIG. 5B has a flow chart connector A to connect FIG. 5A with box 104 of FIG. 5A. At box 118 is “the establishing the stabilizing grid and the establishing the projecting net include extrusion of the stabilizing grid and the projecting net simultaneously together as a single lattice.” At box 120 is “the grid warp strands, the grid weft strands, the net warp strands and the net weft strands are composed of a same material.”

Still referring to FIG. 5B, at box 122 is “plastically deforming a plurality of the net warp strands and a plurality of the net weft strands by rolling the single lattice between heated contoured rollers to make the net warp strand portion of each subnet spaced from a minimum surface defined by the corresponding grid cell and to make the net weft strand portion of each subnet spaced from the minimum surface defined by the corresponding grid cell.” At box 124 is “after the plastically deforming, setting the plurality of subnets by cooling the single lattice to stabilize the single lattice as the three-dimensional lattice wherein original cell shapes are retained after the extrusion of the stabilizing grid through the rolling of the single lattice between the heated contoured rollers and the cooling of the single lattice.” Flow chart connector B connects box 124 of FIG. 5B with the top of FIG. 5C.

FIG. 5C has a flow chart connector B to connect FIG. 5C with box 124 of FIG. 5B as stated above. At box 126 is “the heated contoured rollers include a positive roller and a complementary roller, the positive roller having: a plurality of cogs protruding from a cylindrical roller surface, wherein the plurality of cogs meshingly engage the stabilizing grid without deforming the stabilizing grid and wherein the plurality of cogs plastically deform the plurality of the net warp strands and the plurality of the net weft strands into complementary pockets defined in the complementary roller to receive the cogs with the plurality of subnets rolled between the cogs and the pockets; a plurality of circumferential valleys defined between the cogs, wherein the plurality of circumferential valleys are aligned to receive the grid warp strands without deforming the stabilizing grid; a plurality of longitudinal valleys defined in longitudinal rows between the cogs, wherein the plurality of longitudinal rows are circumferentially spaced on the cylindrical roller surface at intervals equal to a grid weft distance and the plurality of longitudinal valleys are aligned to receive the grid weft strands without deforming the stabilizing grid.”

FIG. 5D has a flow chart connector C to connect FIG. 5D with box 104 of FIG. 5A as stated above. At box 128 is “the establishing the stabilizing grid includes: forming the grid warp strands; forming the grid weft strands; and weaving the grid warp strands and the grid weft strands together to form the stabilizing grid having original cell shapes; the establishing the projecting net includes: forming the net warp strands; forming the net weft strands; and weaving of the net warp strands and the net weft strands together to form an undeformed net.” Flow chart connector D connects box 128 of FIG. 5D with the top of FIG. 5E. Flow chart connector E connects box 128 of FIG. 5D with the top of FIG. 5F. Flow chart connector F connects box 128 of FIG. 5D with the top of FIG. 5G.

FIG. 5E has a flow chart connector D to connect FIG. 5E with box 128 of FIG. 5D as stated above. At box 130 is “the forming the grid warp strands includes extruding the grid warp strands; and the forming the grid weft strands includes extruding the grid weft strands.”

FIG. 5F has a flow chart connector E to connect FIG. 5F with box 128 of FIG. 5D as stated above. At box 132 is “the forming the grid warp strands includes pultruding the grid warp strands with fiberglass or carbon fibers and the forming the grid weft strands includes pultruding the grid weft strands with fiberglass or carbon fibers.”

FIG. 5J has a flow chart connector J to connect FIG. 5J with box 128 of FIG. 5D as stated above. At box 133 is “the weaving the grid warp strands and the grid weft strands together to form the stabilizing grid and the weaving of the net warp strands and the net weft strands together to form the undeformed net are performed simultaneously and together to interweave the stabilizing grid and the undeformed net into a single lattice.

FIG. 5G has a flow chart connector F to connect FIG. 5G with box 128 of FIG. 5D as stated above. At box 134 is “merging the stabilizing grid into contact with the undeformed net; joining the stabilizing grid and the undeformed net together to form a double-layer network; plastically deforming a plurality of the net warp strands and a plurality of the net weft strands by rolling the double-layer network between heated contoured rollers to make the net warp strand portion of each subnet spaced from a minimum surface defined by the corresponding grid cell and to make the net weft strand portion of each subnet spaced from the minimum surface defined by the corresponding grid cell; and after the plastically deforming, setting the plurality of subnets by cooling the double-layer network to stabilize the double-layer network in form of the three-dimensional lattice, wherein the original cell shapes are retained after being woven through the rolling of the double-layer network between the heated contoured rollers and the cooling of the double-layer network.” Flow chart connector G connects box 134 of FIG. 5G with the top of FIG. 5H.

FIG. 5H has a flow chart connector G to connect FIG. 5H with box 134 of FIG. 5G as stated above. At box 136 is “the heated contoured rollers include a positive roller and a complementary roller, the positive roller having: a plurality of cogs protruding from a cylindrical roller surface, wherein the plurality of cogs meshingly engage the stabilizing grid without deforming the stabilizing grid and wherein the plurality of cogs plastically deform the plurality of the net warp strands and the plurality of the net weft strands into complementary pockets defined in the complementary roller to receive the cogs with the plurality of subnets rolled between the cogs and the pockets; a plurality of circumferential valleys defined between the cogs, wherein the plurality of circumferential valleys are aligned to receive the grid warp strands without deforming the stabilizing grid; and a plurality of longitudinal valleys defined in longitudinal rows between the cogs, wherein the plurality of longitudinal rows are circumferentially spaced on the cylindrical roller surface at intervals equal to a grid weft distance and the plurality of longitudinal valleys are aligned to receive the grid weft strands without deforming the stabilizing grid.”

FIG. 5I has a flow chart connector H to connect FIG. 5I with box 104 of FIG. 5A as stated above. At box 138 is “the establishing the stabilizing grid and the establishing the projecting net together include weaving the grid warp strands, the grid weft strands, the net warp strands, and the net weft strands together using slack-tension weaving to cause the plurality of subnets to pucker in the corresponding grid cells.”

Reference throughout the specification to “one example”, “another example”, “an example”, and so forth, means that a particular element (e.g., feature, structure, and/or characteristic) described in connection with the example is included in at least one example described herein, and may or may not be present in other examples. In addition, it is to be understood that the described elements for any example may be combined in any suitable manner in the various examples unless the context clearly dictates otherwise.

It is to be understood that the ranges provided herein include the stated range and any value or sub-range within the stated range. For example, a range of from about 30 degrees to about 45 degrees should be interpreted to include not only the explicitly recited limits of from about 30 degrees to about 45 degrees, but also to include individual values, such as 32 degrees, 35.7 degrees, etc., and sub-ranges, such as from about 35 degrees to about 40 degrees, etc. Furthermore, when “about” is utilized to describe a value, this is meant to encompass minor variations (up to +/−10 percent) from the stated value.

In describing and claiming the examples disclosed herein, the singular forms “a”, “an”, and “the” include plural referents unless the context clearly dictates otherwise.

While several examples have been described in detail, it is to be understood that the disclosed examples may be modified. Therefore, the foregoing description is to be considered non-limiting.

1. A three-dimensional lattice, comprising:
a stabilizing grid having grid warp strands and grid weft strands crossing the grid warp strands wherein grid cells are defined by adjacent grid warp strands and adjacent grid weft strands intersecting the adjacent grid warp strands;
a projecting net having net warp strands and net weft strands crossing the net warp strands; and
a plurality of subnets, each subnet of the plurality uniquely corresponding to a corresponding grid cell, wherein:
each subnet includes a net warp strand portion intersecting both of the grid weft strands that define the corresponding grid cell;
each subnet includes a net weft strand portion intersecting both of the grid warp strands that define the corresponding grid cell;
the net warp strand portion of each subnet is spaced from a minimum surface defined by the corresponding grid cell; and
the net weft strand portion of each subnet is spaced from the minimum surface defined by the corresponding grid cell.

2. The three-dimensional lattice as defined in claim 1 wherein each subnet has a subnet node defined at an intersection of the net warp strand portion and the net weft strand portion of each subnet.

3. The three-dimensional lattice as defined in claim 1 wherein the grid warp strands and the grid weft strands include reinforcing fibers and a thermoplastic resin.

4. The three-dimensional lattice as defined in claim 1 wherein the grid warp strands and the grid weft strands have a higher glass transition temperature or a higher softening point resin than the net warp strands and the net weft strands.

5. The three-dimensional lattice as defined in claim 1 wherein at least one of the grid warp strands or at least one of the grid weft strands includes a grid active material.

6. The three-dimensional lattice as defined in claim 1 wherein at least one of the net warp strands or at least one of the net weft strands includes a net active material.

7. A seat for supporting a seat occupant, comprising:
the three-dimensional lattice as defined in claim 1; and
a seating surface defined on the seat, wherein at least one of the grid warp strands, at least one of the grid weft strands, at least one of the net warp strands or at least one of the net weft strands includes an active material.

8. The seat as defined in claim 7, further comprising a pressure sensor operatively connected to the seating surface of the seat wherein the active material included in at least one of the grid warp strands, the active material included in at least one of the grid weft strands, the active material included in at least one of the net warp strands or the active material included in at least one of the net weft strands define a Wheatstone Bridge for pressure sensing.

9. The seat as defined in claim 7, further comprising a heating layer or a cooling layer operatively connected to the seating surface of the seat wherein the at least one of the grid warp strands including the active material, the at least one of the grid weft strands including the active material, the at least one of the net warp strands including the active material or the at least one of the net weft strands including the active material are operatively included in the heating layer or the cooling layer.

10. A method of making a three-dimensional lattice, comprising:
establishing a stabilizing grid having grid warp strands and grid weft strands crossing the grid warp strands wherein grid cells are defined by adjacent grid warp strands and adjacent grid weft strands intersecting the adjacent grid warp strands; and
establishing a projecting net having net warp strands and net weft strands crossing the net warp strands, wherein:
each subnet in a plurality of subnets uniquely corresponds to a grid cell;
each subnet includes a net warp strand portion intersecting both of the grid weft strands that define the corresponding grid cell;
each subnet includes a net weft strand portion intersecting both of the grid warp strands that define the corresponding grid cell;
the net warp strand portion of each subnet is spaced from a minimum surface defined by the corresponding grid cell; and
the net weft strand portion of each subnet is spaced from the minimum surface defined by the corresponding grid cell.

11. The method as defined in claim 10 wherein the grid warp strands and the grid weft strands have a higher glass transition temperature or a higher softening point resin than the net warp strands and the net weft strands.

12. The method as defined in claim 10 wherein:
the establishing the stabilizing grid and the establishing the projecting net include extrusion of the stabilizing grid and the projecting net simultaneously together as a single lattice; and
the grid warp strands, the grid weft strands, the net warp strands and the net weft strands are composed of a same material.

13. The method as defined in claim 12, further comprising:
plastically deforming a plurality of the net warp strands and a plurality of the net weft strands by rolling the single lattice between heated contoured rollers to make the net warp strand portion of each subnet spaced from a minimum surface defined by the corresponding grid cell and to make the net weft strand portion of each subnet spaced from the minimum surface defined by the corresponding grid cell; and
after the plastically deforming, setting the plurality of subnets by cooling the single lattice to stabilize the single lattice as the three-dimensional lattice wherein original cell shapes are retained after the extrusion of the stabilizing grid through the rolling of the single lattice between the heated contoured rollers and the cooling of the single lattice.

14. The method as defined in claim 13 wherein the heated contoured rollers include a positive roller and a complementary roller, the positive roller having:
a plurality of cogs protruding from a cylindrical roller surface, wherein the plurality of cogs meshingly engage the stabilizing grid without deforming the stabilizing grid and wherein the plurality of cogs plastically deform the plurality of the net warp strands and the plurality of the net weft strands into complementary pockets defined in the complementary roller to receive the cogs with the plurality of subnets rolled between the cogs and the pockets;
a plurality of circumferential valleys defined between the cogs, wherein the plurality of circumferential valleys are aligned to receive the grid warp strands without deforming the stabilizing grid;
a plurality of longitudinal valleys defined in longitudinal rows between the cogs, wherein the plurality of longitudinal rows are circumferentially spaced on the cylindrical roller surface at intervals equal to a grid weft distance and the plurality of longitudinal valleys are aligned to receive the grid weft strands without deforming the stabilizing grid.

15. The method as defined in claim 10 wherein:
the establishing the stabilizing grid includes:
forming the grid warp strands;
forming the grid weft strands; and
weaving the grid warp strands and the grid weft strands together to form the stabilizing grid having original cell shapes; and
the establishing the projecting net includes:
forming the net warp strands;
forming the net weft strands; and
weaving of the net warp strands and the net weft strands together to form an undeformed net.

16. The method as defined in claim 15 wherein:
the forming the grid warp strands includes extruding the grid warp strands;
the forming the grid weft strands includes extruding the grid weft strands;
the forming the net warp strands includes extruding the net warp strands; or
the forming the net weft strands includes extruding the net weft strands.

17. The method as defined in claim 15 wherein:
the forming the grid warp strands includes pultruding the grid warp strands with fiberglass or carbon fibers;
the forming the grid weft strands includes pultruding the grid weft strands with fiberglass or carbon fibers;
the forming the net warp strands includes pultruding the net warp strands with fiberglass or carbon fibers; or
the forming the net weft strands includes pultruding the net weft strands with fiberglass or carbon fibers.

18. The method as defined in claim 15 wherein the weaving the grid warp strands and the grid weft strands together to form the stabilizing grid and the weaving of the net warp strands and the net weft strands together to form the undeformed net are performed simultaneously and together to interweave the stabilizing grid and the undeformed net into a single lattice.

19. The method as defined in claim 15, further including:
merging the stabilizing grid into contact with the undeformed net;
joining the stabilizing grid and the undeformed net together to form a double-layer network;
plastically deforming a plurality of the net warp strands and a plurality of the net weft strands by rolling the double-layer network between heated contoured rollers to make the net warp strand portion of each subnet spaced from a minimum surface defined by the corresponding grid cell and to make the net weft strand portion of each subnet spaced from the minimum surface defined by the corresponding grid cell; and
after the plastically deforming, setting the plurality of subnets by cooling the double-layer network to stabilize the double-layer network in form of the three-dimensional lattice, wherein the original cell shapes are retained after being woven through the rolling of the double-layer network between the heated contoured rollers and the cooling of the double-layer network.

20. The method as defined in claim 19 wherein the heated contoured rollers include a positive roller and a complementary roller, the positive roller having:
a plurality of cogs protruding from a cylindrical roller surface, wherein the plurality of cogs meshingly engage the stabilizing grid without deforming the stabilizing grid and wherein the plurality of cogs plastically deform the plurality of the net warp strands and the plurality of the net weft strands into complementary pockets defined in the complementary roller to receive the cogs with the plurality of subnets rolled between the cogs and the pockets;
a plurality of circumferential valleys defined between the cogs, wherein the plurality of circumferential valleys are aligned to receive the grid warp strands without deforming the stabilizing grid; and
a plurality of longitudinal valleys defined in longitudinal rows between the cogs, wherein the plurality of longitudinal rows are circumferentially spaced on the cylindrical roller surface at intervals equal to a grid weft distance and the plurality of longitudinal valleys are aligned to receive the grid weft strands without deforming the stabilizing grid.

21. The method as defined in claim 10 wherein the establishing the stabilizing grid and the establishing the projecting net together include weaving the grid warp strands, the grid weft strands, the net warp strands, and the net weft strands together using slack-tension weaving to cause the plurality of subnets to pucker in the corresponding grid cells.
